(19) United States
(12) Patent Application Publication
(10) Pub. No.: US 2024/0289690 A1
(43) Pub. Date: Aug. 29, 2024

(54) MODEL UPDATE NECESSITY DETERMINATION SYSTEM AND UPDATE NECESSITY DETERMINATION METHOD OF MODEL UPDATE NECESSITY DETERMINATION SYSTEM

(71) Applicant: TOYOTA JIDOSHA KABUSHIKI KAISHA, Toyota-shi (JP)

(72) Inventor: Satoshi UNO, Mishima-shi (JP)

(73) Assignee: TOYOTA JIDOSHA KABUSHIKI KAISHA, Toyota-shi (JP)

(21) Appl. No.: 18/539,500

(22) Filed: Dec. 14, 2023

(30) Foreign Application Priority Data
Feb. 24, 2023 (JP) 2023-027157

(51) Int. Cl. G06N 20/00

(52) U.S. Cl. CPC G06N 20/00

(57) ABSTRACT

A model update necessity determination system is a model update necessity determination system that determines necessity of updating a machine learning model that performs learning using vehicle data under predetermined learning conditions and predicts changes in the behavior of a target vehicle based on target vehicle data acquired from target vehicles within a preset area. The system includes a number-of-deviations calculation unit that calculates the number of deviations in which the target vehicle data deviates from the learning condition based on the target vehicle data of the target vehicles in the area, and an update necessity determination unit that determines the necessity of updating the machine learning model.

### CROSS-REFERENCE TO RELATED APPLICATION

This application claims priority to Japanese Patent Application No. 2023-027157 filed on Feb. 24, 2023, incorporated herein by reference in its entirety.

### BACKGROUND

### 1. Technical Field

The present disclosure relates to a model update necessity determination system and an update necessity determination method of the model update necessity determination system.

### 2. Description of Related Art

Conventionally, Japanese Unexamined Patent Application Publication No. 2020-052607 (JP 2020-052607 A) is known as a technical document regarding a model update necessity determination system. This publication describes a model update necessity determination system that determines whether unstable behavior is caused by a driver when a target vehicle whose information is being collected exhibits unstable behavior.

### SUMMARY

In the model update necessity determination system as described above, it is considered that a machine learning model is used to process information acquired from a large number of target vehicles. An appropriate machine learning model is used for each preset area. However, since the situation within the area changes over time, it is required to appropriately determine the necessity of updating the machine learning model.

A first aspect of the present disclosure is a model update necessity determination system that is a system that determines necessity of updating a machine learning model, the machine learning model being a model with which learning is performed using vehicle data under a predetermined learning condition and that predicts, based on target vehicle data acquired from a target vehicle within a preset area, a behavior change of the target vehicle. The model update necessity determination system includes:
a number-of-deviations calculation unit that calculates, based on the target vehicle data of the target vehicle in the area and the learning condition, the number of deviations that is the number of target vehicle data deviating from the learning condition; and
an update necessity determination unit that determines the necessity of updating the machine learning model based on the number of deviations.

According to the model update necessity determination system according to the first aspect of the present disclosure, by factoring in the number of deviations of target vehicle data in the area based on the learning condition of the machine learning model, it is possible to appropriately determine the necessity of updating the machine learning model in accordance with a change in the situation within the area assigned to the machine learning model.

A second aspect of the present disclosure is
an update necessity determination method of a model update necessity determination system that is a system that determines necessity of updating a machine learning model, the machine learning model being a model with which learning is performed using vehicle data under a predetermined learning condition and that predicts, based on target vehicle data acquired from a target vehicle within a preset area, a behavior change of the target vehicle. The update necessity determination method includes:
calculating, based on the target vehicle data of the target vehicle in the area, the number of deviations that is the number of target vehicle data deviating from the learning condition; and
determining the necessity of updating the machine learning model based on the number of deviations.

According to the update necessity determination method of the model update necessity determination system according to the second aspect of the present disclosure, by factoring in the number of deviations of target vehicle data in the area based on the learning condition of the machine learning model, it is possible to appropriately determine the necessity of updating the machine learning model in accordance with a change in the situation within the area assigned to the machine learning model.

According to the first aspect and the second aspect of the present disclosure, it is possible to appropriately determine the necessity of updating the machine learning model in accordance with a change in the situation within the area assigned to the machine learning model.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a model update necessity determination system according to an embodiment;

FIG. 2 is a diagram for explaining the areas of the machine learning model;

FIG. 3 is a block diagram showing an example of an update determination server;

FIG. 4 is a flowchart showing an example of update necessity determination processing by the update determination server; and

FIG. 5 is a flowchart showing another example of update necessity determination processing by the update determination server.

### DETAILED DESCRIPTION OF EMBODIMENTS

Hereinafter, embodiments of the present disclosure will be described with reference to the drawings.

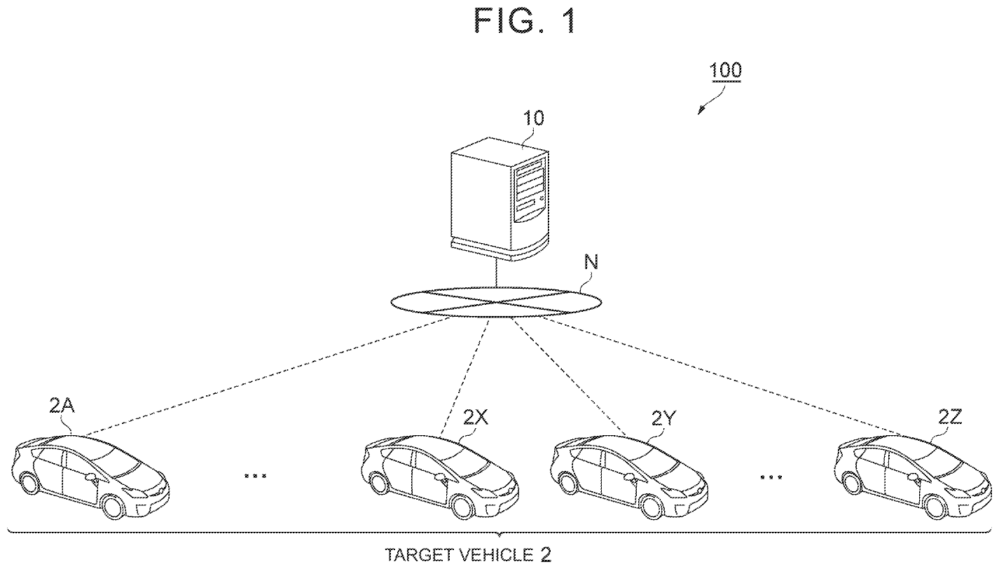

FIG. 1 is a diagram showing a model update necessity determination system 100 according to an embodiment. The model update necessity determination system 100 determines the necessity of updating a machine learning model that predicts changes in the behavior of a target vehicle based on target vehicle data acquired from target vehicles within a preset area. The case where it is necessary to update the machine learning model is, for example, when the degree of adaptation of the machine learning model to the situation within the area is low. The machine learning model is a trained model that has been trained using vehicle data under predetermined learning conditions. Details of the machine learning model, learning conditions, and areas will be described later.

As shown in FIG. 1, in the model update necessity determination system 100, target vehicles 2 (target vehicles 2A to 2Z) are communicably connected to an update determination server 10 via a network N. Network N is a wireless communication network. As the network N, a well-known network can be used for wireless communication.

The target vehicle 2 is a vehicle from which the model update necessity determination system 100 collects information. The target vehicle 2 is assigned an identification (ID) (vehicle identification number) for identifying the vehicle. The number of target vehicles may be one. The target vehicles 2 do not need to have the same configuration, and may be of different vehicle types. The target vehicle may be a self-driving vehicle or a vehicle that does not have a self-driving function. The target vehicle 2 in this embodiment is a support target vehicle that receives support such as information provision from a machine learning model. Note that the vehicle to be supported may be included in the target vehicles 2 for information collection, or may not be included in the target vehicles 2.

The target vehicle data collected by the model update necessity determination system 100 includes position information of the target vehicle 2. Location information is generated in relation to time. The target vehicle data may include an ID. The target vehicle data may include vehicle speed information of the target vehicle 2, acceleration information, steering angle information, and yaw rate information. The target vehicle data may include object detection information regarding objects around the target vehicle 2 detected by the sensor of the target vehicle 2, and may also include information on the traveling position with respect to the lane. The target vehicle data may include driver operation information. The object detection information may include position information of the object as seen from the target vehicle 2 and object type information. The object type information includes information regarding types of objects such as pedestrians, bicycles, two-wheeled vehicles, four-wheeled vehicles, and stationary objects such as walls.

Furthermore, the target vehicle data may include wiper operation information of the target vehicle 2. The target vehicle data may include road surface friction information calculated by the on-vehicle equipment of the target vehicle 2, and may include outside temperature information detected by the temperature sensor of the target vehicle 2. The target vehicle data may include an image captured by an external camera of the target vehicle 2. The various types of information described above are associated with the position information and time of the target vehicle 2.

The machine learning model is, for example, a neural network such as a convolutional neural network (CNN). Neural networks can include multiple layers, including multiple convolutional layers and pooling layers. As the neural network, a deep learning network based on deep learning may be used.

The machine learning model inputs the target vehicle data collected from the target vehicle 2 and outputs a prediction result of the behavior change of the target vehicle 2. The behavior change of the target vehicle 2 is, for example, the occurrence of unstable behavior. The unstable behavior is a sudden change in behavior that makes the running of the target vehicle 2 unstable. Unstable behavior includes slipping. Unstable behavior may include sudden deceleration or sudden changes in steering angle. The unstable behavior may include lane departure of the target vehicle 2, or may include excessive approach of the target vehicle 2 to an object (rear-end collision warning, etc.).

The machine learning model outputs a prediction result of unstable behavior in the target vehicle 2 (reproducibility determination result of unstable behavior) based on the target vehicle data, for example. The machine learning model determines reproducibility by extracting feature amounts from the target vehicle data of the target vehicle 2 in which unstable behavior has been detected. As the feature amount, arbitrary parameters can be used from the vehicle speed, acceleration, tire pressure drop, weight, vehicle size (vehicle height, vehicle width), vehicle type, driver's driving tendency, etc. of the target vehicle 2. A decrease in tire air pressure is, for example, a state in which the tire air pressure is less than a predetermined threshold value. A driver's driving tendency can be determined from past driving operation information of the driver. The driver's years of driving experience, age, gender, and other information may be used to determine the driver's driving tendency. As additional feature amounts, the time when unstable behavior occurred in the target vehicle 2, outside temperature, road conditions, etc. may be used. For example, the machine learning model predicts unstable behavior by comparing the feature amount extracted from the target vehicle data of the target vehicle 2 in which unstable behavior has been detected and the feature amount extracted from the target vehicle data of the target vehicle 2 that is the prediction target. The reproducibility determination of unstable behavior is described in, for example, Japanese Patent Application No. 2022-187683 and Japanese Patent Application No. 2022-145185. Behavior changes may include changes in behavior other than unstable behavior.

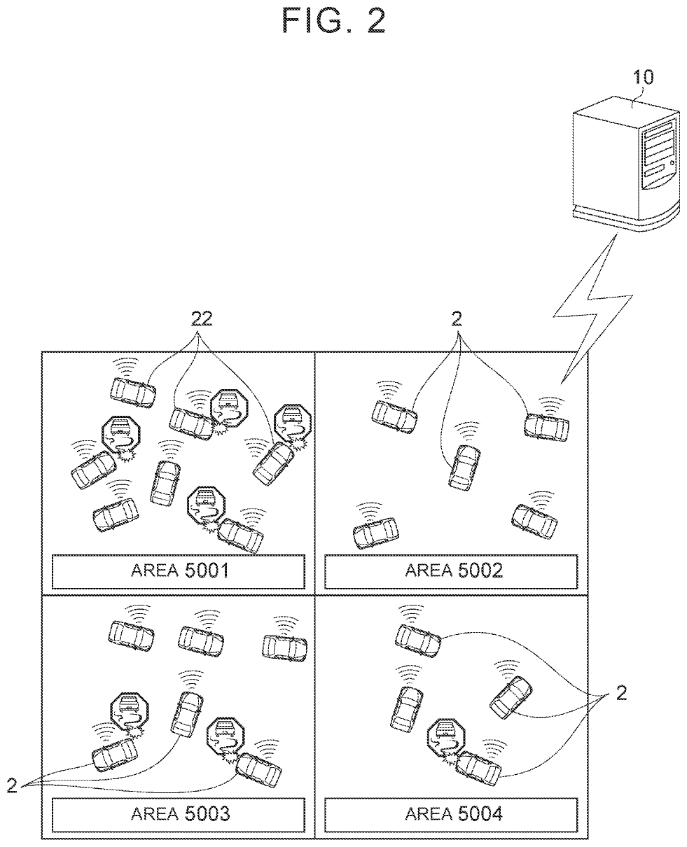

The machine learning model used is a model tailored to a preset area. Here, FIG. 2 is a diagram for explaining areas of the machine learning model. As shown in FIG. 2, the area is set, for example, on a map, divided into certain ranges in a mesh shape. The area may be set as a 10 km mesh (10 km square), may be set as a 5 km mesh, or may be set as a 3 km mesh. A mesh of 10 km or more may be set. The areas do not need to have the same shape, and may be set as areas where the environment tends to be uniform depending on the topography. The area may be configured as a mesh code. The mesh code is defined based on latitude and longitude information, and a unique code is assigned to each mesh.

An appropriate machine learning model is adopted depending on, for example, the presence or absence of major roads in the area, the proportion of residential areas or commercial areas in the area, etc. The machine learning model has been trained using vehicle data (for example, past target vehicle data) under predetermined learning conditions. The vehicle data used for learning is not limited to the target vehicle data of the target vehicle 2, but data of a probe vehicle that is not connected to the update determination server 10, etc. may be used.

The learning conditions include, for example, at least one of an outside temperature range, a position range, a vehicle speed range, a time range, and the like. Specifically, the outside temperature range as a learning condition means that learning is performed based on target vehicle data when the outside temperature is within a range of 19° C. to 25° C., for example. In this case, the target vehicle data where the outside temperature is less than 19° C. is data that deviates from the learning conditions (data that the machine learning model cannot handle). The range of positions as a learning condition means, for example, that an area includes six areas (area A, area B, area C, area D, area E, and area F), but at the time of learning, area A, area This means that the learning was performed based on the target vehicle data of the target vehicle 2 traveling in the B area, the C area, and the D area. In this case, the target vehicle data of the target vehicle 2 traveling in the E zone or the F zone becomes data that deviates from the learning conditions.

Similarly, the range of vehicle speed as a learning condition means that learning is performed based on target vehicle data of target vehicle 2 whose vehicle speed is within a range of 60 km/h or less, for example. In this case, the target vehicle data of the target vehicle 2 having a vehicle speed exceeding 60 km/h becomes data that deviates from the learning conditions. The time range as a learning condition means that learning is performed based on target vehicle data from 6:00 a.m. to 12:00 p.m., for example. In this case, the target vehicle data from after 12:00 p.m. to 6:00 a.m. becomes data that deviates from the learning conditions. Learning conditions may be set by narrowing down target vehicle data to improve prediction accuracy in an area, or may occur due to a lack of target vehicle data at the time of learning.

### Configuration of Model Update Necessity Determination System

The configuration of the model update necessity determination system 100 according to this embodiment will be described below. A model update necessity determination system 100 shown in FIG. 1 includes an update determination server 10. The model update necessity determination system 100 may be configured to include at least a portion of the on-vehicle computing devices of the target vehicles 2A to 2Z.

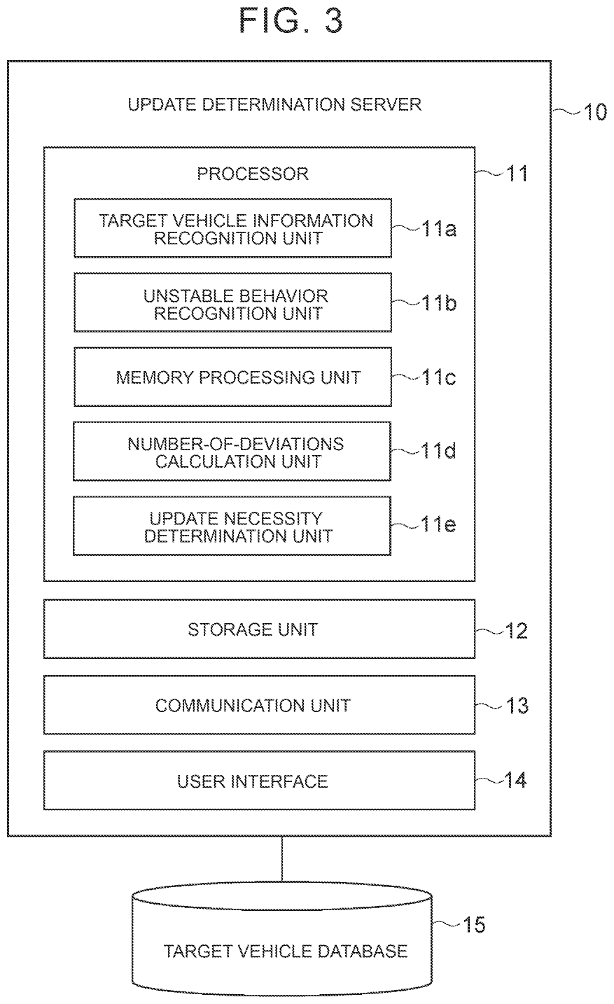

The update determination server 10 is installed in a facility such as an information management center, and is configured to be able to communicate with the target vehicles 2A to 2Z. FIG. 3 is a block diagram showing an example of the configuration of the update determination server 10. The update determination server 10 shown in FIG. 3 is configured as a general computer including a processor 11, a storage unit 12, a communication unit 13, and a user interface 14.

The processor 11 controls the update determination server 10 by, for example, operating an operating system. The processor 11 is an arithmetic unit such as a central processing unit (CPU) that includes a control device, an arithmetic device, registers, and the like. The processor 11 controls the storage unit 12, the communication unit 13, and the user interface 14. The storage unit 12 is configured to include at least one of memory and storage. The memory is a recording medium such as Read Only Memory (ROM) or Random Access Memory (RAM). The storage is a recording medium such as a Hard Disk Drive (HDD).

The communication unit 13 is a communication device for communicating via the network N. For the communication unit 13, a network device, a network controller, a network card, etc. can be used. The user interface 14 is a device that includes an output device such as a display and a speaker, and an input device such as a touch panel. Note that the update determination server 10 does not necessarily need to be installed in a facility, and may be installed in a moving object such as a vehicle or a ship. The update determination server 10 may be composed of a plurality of servers.

The update determination server 10 is connected to a target vehicle database 15 that stores target vehicle data of the target vehicle 2 in the past. The target vehicle database 15 has a storage device such as an HDD, and can have the same configuration as a well-known database.

The target vehicle database 15 may store target vehicle data in association with a plurality of preset areas. Areas are set, for example, on a map, divided into certain ranges. The area may be set as, for example, a 10 km mesh (10 km square), a 5 km mesh, or a 3 km mesh. A mesh of 10 km or more may be set. The areas do not need to have the same shape, and may be set as areas where the environment tends to be uniform depending on the topography. The area may be configured as a mesh code. The mesh code is defined based on latitude and longitude information, and a unique code is assigned to each mesh.

The position information of the target vehicle 2 can be obtained as latitude and longitude information from the Global Positioning System (GPS) or Global Navigation Satellite System (GNSS) mounted on the target vehicle 2. Not having a map also contributes to cost reduction. Note that the target vehicle database 15 may be configured integrally with the update determination server 10, or may be provided in a facility or the like that is remote from the update determination server 10.

Next, the functional configuration of the processor 11 will be explained. As shown in FIG. 3, the processor 11 includes a target vehicle information recognition unit 11a, an unstable behavior recognition unit 11b, a storage processing unit 11c, a number-of-deviations calculation unit 11d, and an update necessity determination unit 11e.

The target vehicle information recognition unit 11a recognizes target vehicle data transmitted from the target vehicle 2. The target vehicle data is as described above. The target vehicle information recognition unit 11a acquires target vehicle data including position information and time through communication with the target vehicle 2. The target vehicle information recognition unit 11a aggregates target vehicle data within the target period of the area of the machine learning model that determines whether or not updating is necessary. The target period is not particularly limited, and may be one week, one month, or two months or more.

The unstable behavior recognition unit 11b detects unstable behavior of the target vehicle 2 based on the target vehicle data acquired by the target vehicle information recognition unit 11a. The unstable behavior recognition unit 11b may use the operation start condition of a well-known Antilock Brake System (ABS) to detect a slip. For example, an anti-lock brake system operates when a wheel considered to be locked is identified by comparing the wheel speed of each wheel with the estimated vehicle speed. The estimated vehicle speed may be determined from the wheel speed of each wheel up to the point of slippage, or may be determined from the change in acceleration up to the point of slippage.

Furthermore, the unstable behavior recognition unit 11b may use the well-known operation start conditions of Vehicle Stability Control (VSC) or the well-known operation start conditions of Traction Control System (TRC) to detect a slip. The Traction Control System can also be activated if a wheel that is spinning is identified by comparing the wheel speed of each wheel with the estimated vehicle speed. The unstable behavior recognition unit 11b may detect the slip of the target vehicle 2 using other known methods.

The unstable behavior recognition unit 11b may detect sudden deceleration as unstable behavior based on the deceleration detected by the acceleration sensor. In this case, the unstable behavior recognition unit 11b detects sudden deceleration of the target vehicle 2, for example, when the absolute value of the deceleration becomes equal to or greater than the sudden deceleration threshold. The sudden deceleration threshold is a threshold of a preset value. Hereinafter, the threshold value used in the explanation means a threshold value of a preset value.

The unstable behavior recognition unit 11b may detect a sudden change in steering angle as unstable behavior based on the yaw rate detected by the yaw rate sensor. In this case, the unstable behavior recognition unit 11b detects a sudden change in the steering angle of the target vehicle 2, for example, when the yaw rate becomes equal to or higher than the steering angle change threshold. Note that a tire turning angle or a steering angle may be used instead of the yaw rate.

The storage processing unit 11c stores the target vehicle data and unstable behavior data in the target vehicle database 15. The storage processing unit 11c may store the unstable behavior data in association with the identification ID of the target vehicle 2 as part of the target vehicle data.

The number-of-deviations calculation unit 11d calculates the number of deviations in which the target vehicle data deviates from the learning conditions of the machine learning model, based on the target vehicle data of the target vehicle 2 in the area and the learning conditions of the machine learning model stored in advance. The number-of-deviations calculation unit 11d may calculate the number of deviations for each area, or may calculate the number of deviations by summing the number of deviations in a plurality of areas covered by one machine learning model.

For example, when the outside temperature range as a learning condition is from 19° C. to 25° C., the number-of-deviations calculation unit 11d adds the deviation number when detecting target vehicle data in which the outside temperature is less than 19° C. For example, when the vehicle speed range as a learning condition is 60 km/h or less, the number-of-deviations calculation unit 11d adds the deviation number when detecting target vehicle data in which the vehicle speed exceeds 60 km/h.

The update necessity determination unit 11e determines whether the machine learning model needs to be updated (whether the fitness of the machine learning model is high or low). The update necessity determination unit 11e determines, for example, whether a predetermined period of time has passed since the machine learning model was updated. The predetermined period is a preset period. The predetermined period is not particularly limited. The predetermined period may be six months or one year. The update necessity determination unit 11e determines that updating the machine learning model is unnecessary if a predetermined period of time has not passed since the update of the machine learning model.

When it is determined that a predetermined period of time has passed since the update of the machine learning model, the update necessity determination unit 11e determines whether or not the machine learning model needs to be updated based on the number of deviations. The update necessity determination unit 11e determines whether updating is necessary for each machine learning model. The update necessity determination unit 11e determines that the machine learning model needs to be updated, for example, when the duration of time during which the number of deviations is equal to or greater than the update determination threshold is equal to or greater than the continuation determination threshold. The period of time during which the number of deviations is equal to or greater than the update determination threshold is the time during which the state in which the number of deviations is equal to or greater than the update determination threshold (a state in which there is a deviation tendency) continues. The update determination threshold and the continuation determination threshold are threshold values set in advance. The update determination threshold and the continuation determination threshold can be set to arbitrary values from the viewpoint of updating the machine learning model. The update necessity determination unit 11e resets the duration count and starts counting from zero when the repeatedly calculated number of deviations becomes less than the update determination threshold even once.

Note that the number-of-deviations calculation unit 11d may calculate, as the number of deviations, the number of unstable deviations in which the target vehicle data deviates from the learning conditions when unstable behavior occurs in the target vehicle 2. The number-of-deviations calculation unit 11d can calculate the number of unstable deviations based on the target vehicle data of the target vehicle 2 in the area, the learning conditions of the machine learning model, and the unstable behavior recognized by the unstable behavior recognition unit 11b.

In this case, the number-of-deviations calculation unit 11d narrows down the target vehicle data to data when the target vehicle 2 exhibits unstable behavior, and then calculates the number of deviations in which the target vehicle data deviates from the learning conditions of the machine learning model. The update necessity determination unit 11e may determine whether the machine learning model needs to be updated based on the number of unstable deviations. The update necessity determination unit 11e may determine that the machine learning model needs to be updated when the duration of time during which the number of unstable deviations is equal to or greater than the update determination threshold is equal to or greater than the continuation determination threshold.

In addition to the number of unstable deviations, the number-of-deviations calculation unit 11d may calculate the number of normal deviations in which the target vehicle data deviates from the learning conditions when unstable behavior does not occur. The number of deviations under normal conditions can be taken as a leading indicator of the number of unstable deviations. The update necessity determination unit 11e may set the continuation determination threshold to a smaller value when the number of deviations during normal operation is equal to or greater than the early determination threshold than when the number of deviations during normal operation is less than the early determination threshold. The early determination threshold is a threshold of a preset value. The update necessity determination unit 11e determines that the machine learning model needs to be updated when the duration time during which the number of unstable deviations is equal to or greater than the update determination threshold is equal to or greater than the continuation determination threshold. As a result, the model update necessity determination system 100 can determine that the machine learning model needs to be updated at an appropriate timing by grasping changes in the situation of the area at an early stage and considering the impact on the prediction accuracy of the number of unstable deviations.

### Method for Determining the Necessity of Updating the Model Update Necessity Determination System

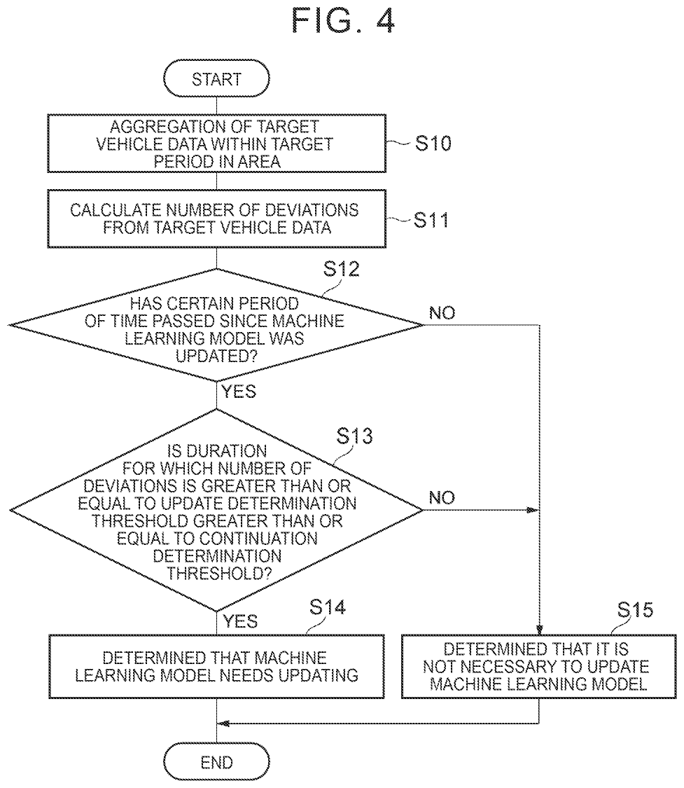

Next, a method for determining the model update necessity determination system 100 according to the present embodiment will be described with reference to the drawings. FIG. 4 is a flowchart illustrating an example of update necessity determination processing (update necessity determination method) of the update determination server 10. The model update necessity determination system 100 executes update necessity determination processing, for example, every fixed period.

As shown in FIG. 4, in step S10, the update determination server 10 of the model update necessity determination system 100 calculates target vehicle data within the target period in the area of the machine learning model for which update necessity is determined by the target vehicle information recognition unit 11a. After that, the update determination server 10 moves to S11.

In S11, the update determination server 10 calculates the number of deviations using the number-of-deviations calculation unit 11d. The number-of-deviations calculation unit 11d calculates the number of deviations in which the target vehicle data deviates from the learning conditions of the machine learning model, based on the target vehicle data of the target vehicle 2 in the area and the learning conditions of the machine learning model. The number-of-deviations calculation unit 11d may calculate, as the number of deviations, the number of unstable deviations in which the target vehicle data deviates from the learning conditions when the target vehicle 2 exhibits unstable behavior. After that, the update determination server 10 moves to S12.

In S12, the update determination server 10 determines whether a predetermined period of time has elapsed since the update of the machine learning model using the update necessity determination unit 11e. When the update determination server 10 determines that a predetermined period of time has passed since the update of the machine learning model (S12: YES), the process proceeds to S13. If the update determination server 10 does not determine that the predetermined period has passed since the update of the machine learning model (S12: NO), the process proceeds to S15.

In S13, the update determination server 10 uses the update necessity determination unit 11e to determine whether the duration for which the number of deviations is equal to or greater than the update determination threshold is equal to or greater than the continuation determination threshold. When the update determination server 10 determines that the duration during which the number of deviations is equal to or greater than the update determination threshold is equal to or greater than the continuation determination threshold (S13: YES), the process proceeds to S14. If the update determination server 10 does not determine that the duration for which the number of deviations is equal to or greater than the update determination threshold is equal to or greater than the continuation determination threshold (S13: NO), the process proceeds to S15.

In S14, the update determination server 10 determines that the machine learning model needs to be updated by the update necessity determination unit 11e. The update determination server 10 may notify a predetermined destination that it has been determined that the machine learning model needs to be updated. Thereafter, the update determination server 10 ends the update necessity determination process.

In S15, the update determination server 10 determines that the update of the machine learning model is not required by the update necessity determination unit 11e. Thereafter, the update determination server 10 ends the update necessity determination process.

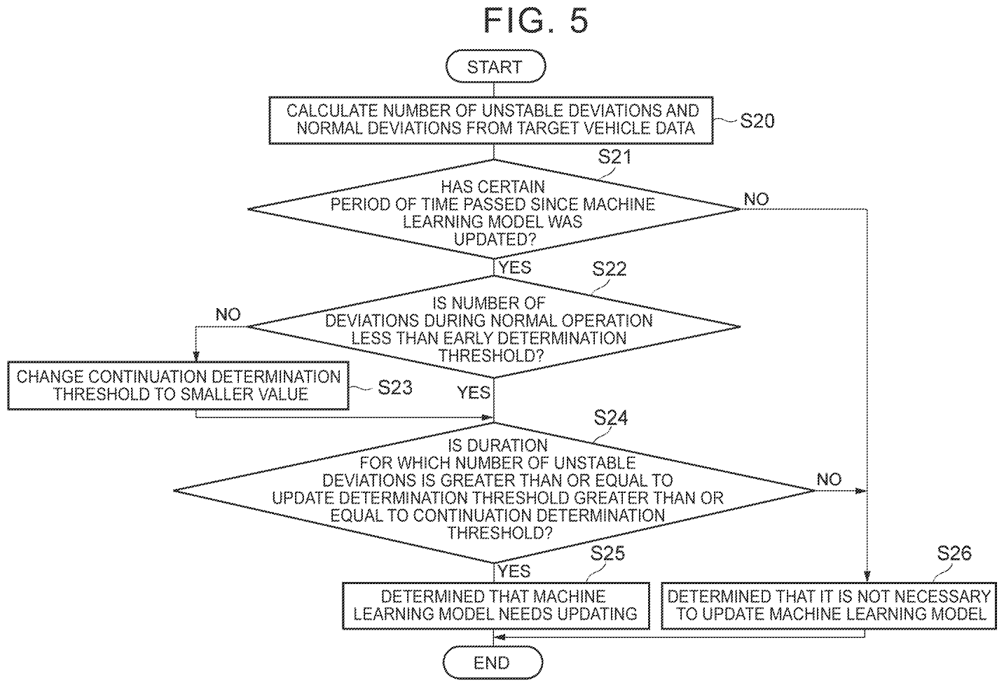

FIG. 5 is a flowchart showing another example of update necessity determination processing by the update determination server. It is assumed that the process in FIG. 5 is executed after the aggregation in S11 in FIG. 4.

As shown in FIG. 5, in S20, the update determination server 10 calculates the number of deviations using the number-of-deviations calculation unit 11d. The number-of-deviations calculation unit 11d calculates the numbers of unstable deviations and normal deviations based on the target vehicle data of the target vehicle 2 in the area, the learning conditions of the machine learning model, and the unstable behavior recognized by the unstable behavior recognition unit 11b. After that, the update determination server 10 moves to S21.

In S21, the update determination server 10 determines whether a predetermined period of time has passed since the update of the machine learning model using the update necessity determination unit 11e. When the update determination server 10 determines that a predetermined period of time has passed since the update of the machine learning model (S21: YES), the process proceeds to S22. If the update determination server 10 does not determine that the predetermined period has passed since the update of the machine learning model (S21: NO), the process proceeds to S26.

In S22, the update determination server 10 determines whether the number of normal deviations is less than the early determination threshold using the update necessity determination unit 11e. When the update determination server 10 determines that the number of normal deviations is less than the early determination threshold (S22: YES), the process proceeds to S24. If the update determination server 10 does not determine that the number of normal deviations is less than the early determination threshold (S22: NO), the process proceeds to S23.

In S23, the update determination server 10 changes the continuation determination threshold to a smaller value by the update necessity determination unit 11e. The update necessity determination unit 11e changes the continuation determination threshold to a second value smaller than the initial value, for example. After that, the update determination server 10 moves to S24.

In S24, the update determination server 10 uses the update necessity determination unit 11e to determine whether the duration for which the number of unstable deviations is equal to or greater than the update determination threshold is equal to or greater than the continuation determination threshold. If the update determination server 10 determines that the duration during which the number of unstable deviations is equal to or greater than the update determination threshold is equal to or greater than the continuation determination threshold (S24: YES), the process proceeds to S25. If the update determination server 10 does not determine that the duration of time during which the number of unstable deviations is equal to or greater than the update determination threshold is equal to or greater than the continuation determination threshold (S24: NO), the process proceeds to S26.

In S25, the update determination server 10 determines that the machine learning model needs to be updated by the update necessity determination unit 11e. The update determination server 10 may notify a predetermined destination that it has been determined that the machine learning model needs to be updated. Thereafter, the update determination server 10 ends the update necessity determination process.

In S26, the update determination server 10 determines that the update of the machine learning model is not required by the update necessity determination unit 11c. Thereafter, the update determination server 10 ends the update necessity determination process.

According to the model update necessity determination system 100 (and the update necessity determination method of the model update necessity determination system 100) according to the present embodiment described above, the number of deviations of target vehicle data is determined based on the learning conditions of the machine learning model. By considering this, it is possible to appropriately determine whether or not to update the machine learning model in accordance with changes in the situation within the area.

Furthermore, in the model update necessity determination system 100, the number of unstable deviations may be used as the number of deviations. In this case, it becomes possible that the model update necessity determination system 100 determines whether the machine learning model needs to be updated based on the influence of the machine learning model on the prediction result (reproducibility determination result) of the unstable behavior of the target vehicle 2.

In addition, in the model update necessity determination system 100, when the number of normal deviations is equal to or greater than the early determination threshold, the continuation determination threshold may be set to a smaller value than when the normal deviation number is less than the early determination threshold. In this case, the model update necessity determination system 100 can determine that it is necessary to grasp changes in the situation of the area early and update the machine learning model at an appropriate timing based on the influence on the prediction accuracy of the number of unstable deviations.

Although the embodiments of the present disclosure have been described above, the present disclosure is not limited to the embodiments described above. The present disclosure can be implemented in various forms including the embodiments described above, with various changes and improvements based on the knowledge of those skilled in the art.

The update determination server 10 of the model update necessity determination system 100 does not necessarily need to be connected to the target vehicle 2 through direct communication. The update determination server 10 may be configured to acquire target vehicle data via another server. In this case, the update determination server 10 does not need to have the target vehicle information recognition unit 11a.

Similarly, the update determination server 10 may acquire unstable behavior data from another server. In this case, the update determination server 10 does not need to have the unstable behavior recognition unit 11b.

The model update necessity determination system 100 may use the number of continuations instead of the continuation time during which the number of deviations is equal to or greater than the update determination threshold. When the number of deviations is calculated every fixed period, the number of times the number of deviations has been continuously determined to be equal to or greater than the update determination threshold can be used instead of the continuous time.

The update necessity determination unit 11e does not necessarily need to determine whether a predetermined period of time has passed since the update of the machine learning model. Further, the update necessity determination unit 11e does not necessarily need to use the duration during which the number of deviations is equal to or greater than the update determination threshold for determination. The update necessity determination unit 11e may determine that the machine learning model needs to be updated without counting the duration when the number of deviations is equal to or greater than the update essential threshold. The update essential threshold is a threshold of a preset value. The update necessity threshold can be set to a value larger than the update determination threshold when the duration during which the number of deviations is equal to or greater than the update determination threshold is also used for determination.

What is claimed is:

1. A model update necessity determination system that is a system that determines necessity of updating a machine learning model, the machine learning model being a model with which learning is performed using vehicle data under a predetermined learning condition and that predicts, based on target vehicle data acquired from a target vehicle within a preset area, a behavior change of the target vehicle, the model update necessity determination system comprising:
a number-of-deviations calculation unit that calculates, based on the target vehicle data of the target vehicle in the area and the learning condition, the number of deviations that is the number of target vehicle data deviating from the learning condition; and
an update necessity determination unit that determines the necessity of updating the machine learning model based on the number of deviations.

2. The model update necessity determination system according to claim 1, wherein the update necessity determination unit determines that the machine learning model needs to be updated when a duration of time during which the number of deviations is equal to or greater than an update determination threshold is equal to or greater than a continuation determination threshold.

3. The model update necessity determination system according to claim 1, wherein:
the machine learning model predicts an occurrence of unstable behavior that is a sudden change in behavior of the target vehicle; and
the number-of-deviations calculation unit calculates, as the number of deviations, the number of unstable deviations that is the number of target vehicle data deviating from the learning condition when the unstable behavior of the target vehicle occurs.

4. The model update necessity determination system according to claim 1, wherein:
the machine learning model predicts an occurrence of unstable behavior that is a sudden change in behavior of the target vehicle;
the number-of-deviations calculation unit calculates, as the number of deviations, the number of unstable deviations that is the number of target vehicle data deviating from the learning condition when the unstable behavior of the target vehicle occurs and the number of normal deviations that is the number of target vehicle data deviating from the learning condition when the unstable behavior does not occur;
the update necessity determination unit determines that the machine learning model needs to be updated when a duration of time during which the number of unstable deviations is equal to or greater than an update determination threshold is equal to or greater than a continuation determination threshold; and
when the number of normal deviations is equal to or greater than an early determination threshold, the update necessity determination unit sets the continuation determination threshold to a smaller value than the continuation determination threshold when the number of normal deviations is less than the early determination threshold.

5. An update necessity determination method of a model update necessity determination system that is a system that determines necessity of updating a machine learning model, the machine learning model being a model with which learning is performed using vehicle data under a predetermined learning condition and that predicts, based on target vehicle data acquired from a target vehicle within a preset area, a behavior change of the target vehicle, the update necessity determination method comprising:
calculating, based on the target vehicle data of the target vehicle in the area, the number of deviations that is the number of target vehicle data deviating from the learning condition; and
determining the necessity of updating the machine learning model based on the number of deviations.
